(19) United States
(12) Patent Application Publication
(10) Pub. No.: US 2008/0230402 A1
(43) Pub. Date: Sep. 25, 2008

(54) Authentication and identification device for a collectable object

(76) Inventor: James J. Macor, Jackson, NJ (US)

Correspondence Address: JAMES J. MACOR, P.O.BOX 1450, JACKSON, NJ, 08527, US

(21) Appl. No.: 12/156,186

(22) Filed: May 30, 2008

Related U.S. Application Data
(63) Continuation-in-part of application No. 11/493,312, filed on Jul. 26, 2006.

(51) Int. Cl. A47G 1/12; B65D 71/00; G06K 19/00; G09F 3/00

(52) U.S. Cl. 206/81; 235/487; 206/232

(57) ABSTRACT

An authentication and identification device for a collectable object is described. The device comprises a holder formed for assembly with at least one collectable object having certification authenticity, to provide protection and preservation of the collectable object. The holder is further formed to resist disassembly and separation with the collectable object. The device also comprises a covert identification marking that provides a means for a user to view certification authenticity relating to the collectable object. The covert identification marking is nondetachably secured to the authentication and identification device, and, provides a means via a computerized device, for a user to verify certification authenticity and information relating to the collectable object.

### REFERENCES TO RELATED APPLICATIONS

This application is a continuation-in-part of U.S. patent application Ser. No. 11/493,312 filed on Jul. 26, 2006, by the inventor herein, entitled PROTECTION, AUTHENTICATION, IDENTIFICATION DEVICE FOR A COLLECTABLE OBJECT.

### FIELD OF THE INVENTION

The present invention relates to the authentication and identification of collectable objects such as a coins, stamps, currency, gemstones, and baseball cards.

### BACKGROUND OF INVENTION

An industry for authentication and certification of collectables has gained prominence and certification companies such as the Professional Coin Grading Service (PCGS) and the Numismatic Guaranty Corporation (NGC) have developed protective collectable holders to protect collectable objects such as coins, stamps, currency, and baseball cards. They encapsulate and certify authenticity and condition grade of the collectable object. These certified holders usually contain a standard barcode label that is utilized for processing and basic certification data. The information typically relates to the grade, date, denomination, and other basic certification information. However, the barcode label fails to validate that the collectable object has not been deceptively switched with a similar like kind collectable object that is inferior in grade, damaged, or even counterfeit. Although the certification services provide a tamper proof holder, there are documented cases of deceptive practices of removing the collectable object (e.g., coin) from one holder and utilizing the barcode label and grade information of another certified holder to fraudulently represent a different or uncertified collectable. With the advent of electronic trading of collectables, certified images of a collectable object, such as a rare coin, are traded in large numbers over the Internet on a daily basis. Certified coins that have been certified for grade and authenticity by reputable certification services are scanned and imaged as visual proof of their certification and generally trade at a higher price due to the trusted confidence and grading expertise of highly regarded certification services such as PCGS and NGC. PCGS and NGC also provide a very basic authentication protocol via their website that allows a buyer or seller to check the validity of the barcode serial number inherent to a specific certified holder to confirm that the serial number is a legitimate serial number associated with a specific coin, grade, and denomination. Unfortunately, this method of authentication has actually created a false sense of security for buyers and sellers of certified coins, and has even led to additional fraudulent abuses for electronic trading. There are documented cases of counterfeit certified holders that have counterfeit barcode labels, inferior graded coins that have been switched with the actual certified coin, or a counterfeit coin, but the certified holder and label still represents the correct and correlating serial number and certification information when cross references the serial number at the certification service's website. This fraudulent practice of counterfeiting or changing the contents of the certified holder is exceptionally deceptive and creates a false sense of authentication security for a buyer of the traded coin. Such fraudulent practices are exasperated because the serial number is often imaged with the certified collectable and then becomes readily assessable to virtually anyone (in any country) with Internet access. As such, the digital image representation of a certified collectable on the World-Wide-Web does not conceal an authentication key, the barcode serial number, and a counterfeit label can easily be reproduced that has the genuine serial number and condition information and also correlates to the certification service's own authentication protocol via their website. An unsuspecting buyer may even authenticate the serial number at a certification service's website and find it is a legitimate serial number issued by the grading service and the coin likewise appears to correlate with the barcode and grading information by date and denomination. However, the unfortunate buyer is unaware that the coin, the barcode label and serial number, the holder, or all of these items may actually be counterfeit.

A secondary problem relative to online virtual trading of certified collectables is also discussed. Due to the magnitude of online trading by such auction venues as Ebay Inc., the abuse for “virtual” trading and sales of these certified coins has increased fraudulent trading of certified collectables due to the inability of a buyer to examine and scrutinize the certified coin in person. Buyers rely on the digital image of the certified coin and holder for assessment of the eye appeal, graded condition, and other factors, such as the certification service's reputation. However, the digital image of a certified coin or collectable at an auction site, is not a guarantee that the seller even owns the certified collectable. At any given time, there are millions of images of certified collectable items available at major auction sites, auction company archives, and Internet seller markets for potential buyers to browse and view. These very images can be downloaded by unscrupulous individuals and in some cases are utilized as images for sale fraudulently, at an auction site or online trading venue, even though the seller does not actually own the collectable item for sale. It is well known that online images can be downloaded by screenshot commands, and other various computerized and digital imaging methods. Such images of certified coin holders clearly and intentionally display the visible serial number, and although a potential buyer can check the validity of the serial number at the certification service's website, there still remains the aforementioned potential risks for fraudulent sales representation by a non-owner of the certified collectable for Internet based sales. Applicant believes the present invention would provide a valuable security measure that deters fraudulent sales practices of certified collectables and provide greater market confidence in the authentication and trading of certified collectables.

### SUMMARY OF THE INVENTION

In one embodiment of the present invention, an authentication and identification device for a collectable object is described. The device is comprised of a holder formed for assembly with at least one collectable object to provide protection of the collectable object. The holder is further formed to resist disassembly and separation with the collectable object. The device also comprises a covert identification marking that provides a means for authentication of the collectable object. The covert identification marking is nondetachably secured to the authentication and identification device and provides a means via a computerized device, for a user to view one or more digital images of the collectable object to aid the user in the authentication of the collectable object. In one embodiment of the present invention, the covert identification marking is an alphanumeric marking printed with (UV) invisible florescent ink that inhibits reproduction by scanners or photocopiers. In some embodiments of the invention, for example, the collectable object is a coin.

Recognizing the need for an improved authentication and identification device for a collectable object, the following objectives are considered:

It is an important objective of the present invention to provide a security measure for a user to validate authentication of a certified collectable object by means of viewing and evaluating at least one digital image of the collectable object that corresponds to the certification of the collectable, by a trusted source such as a professional certification service. A high quality digital image (or images) of the collectable object that is created and securely stored at the time of certification of the collectable, can serve as a future record to validate authenticity of a certified collectable. For instance, collectable objects such as rare coins, have unique visual characteristics that can promote the identification of the collectable coin, such as striking definition, centering, coloration, abrasions, luster, date of issue, surface wear, mintmarks, and die-varieties. These characteristics can be visually evaluated by a user or buyer to aid in the validation that the certified collectable object has not been deceptively altered or switched with an inferior example or even a counterfeit example. Naturally, other examples of collectables that would benefit from such an authentication and identification device, and would include for example, stamps, baseball cards, gemstones, currency, autograph memorabilia, and historical documents.

It is another important objective of the present invention to provide a user an authentication device that enables the authentication of a certified collectable object by means of a covert identification marking that enables a user to verify certification data via a standard computer system or equivalent system. Thus, a simple user protocol with readily available means is achieved.

It is another important objective of the present invention to provide a practical sized portable authentication and identification device for a collectable object that is tamper resistant and promotes protection of the collectable object stored in the holder to promote preservation of the collectable object.

It is another important objective of the present invention to provide for a means to store the collectable object with the correlating covert identification marking together, in a method that resists disassembly, such as a label that is also stored in the tamper resistant holder. Storing the covert identification marking with the correlating collectable object in a tamper resistant method fosters a higher probability that a user or seller will be required to utilize the authentication and identification device as a means for self authentication and promotes enhanced user and buyer confidence in the authenticity of the certified collectable object.

It is another important objective of the present invention to deter the downloading of digital images of certified collectables by illegitimately agents that fraudulently represent the downloaded image for sale, thus inhibiting fraudulent sales and counterfeit practices for online auctions and Internet sales venues.

It is another important objective of the present invention to provide a covert identification marking for certified collectables that is non-obvious, discreet, or disguised and inhibits reproduction by scanning devices and photocopy devices, thereby maintaining its covert authentication feature even after a digital image is created and posted on the Internet for Internet sales, auction venues, or printed in sales catalogues.

It is another important objective of the present invention to provide a simple means, such as inputting an alphanumeric code via a computerized device that provides a user a simplistic protocol to authenticate the collectable object by means of a trusted remote site that verifies authenticity.

It is another important objective of the present invention to provide a means for a user to easily and securely view additional relevant information of the actual collectable object, such as certification data, production mintages, population survival reports, current valuations, and related historical information and images. Related information to a collectable object, such as historical information related to the collectable object is an important factor for the enjoyment and education for both novice and seasoned collectors.

### BRIEF DESCRIPTION OF DRAWINGS

FIG. 1 shows a right front perspective, exploded view of a present invention device shown disassembled.

FIG. 2 shows a top plan view of a present invention device shown in FIG. 1.

FIG. 3 shows a right front perspective, exploded view of another embodiment of the present invention device shown disassembled.

FIG. 4 shows a right side assembled view of a present invention device shown in FIG. 3 with a magnified top portion of the present invention.

FIG. 5 shows a diagram of a present invention device that is similar to that shown in FIGS. 1 and 2 illustrating a typical corresponding interface with a standard computer system with Internet capability.

FIG. 6 shows a diagram of a present invention device that is similar to that shown in FIGS. 3 and 4 illustrating a typical corresponding interface with a standard computer system with Internet capability.

### DETAILED DESCRIPTION OF THE DRAWINGS

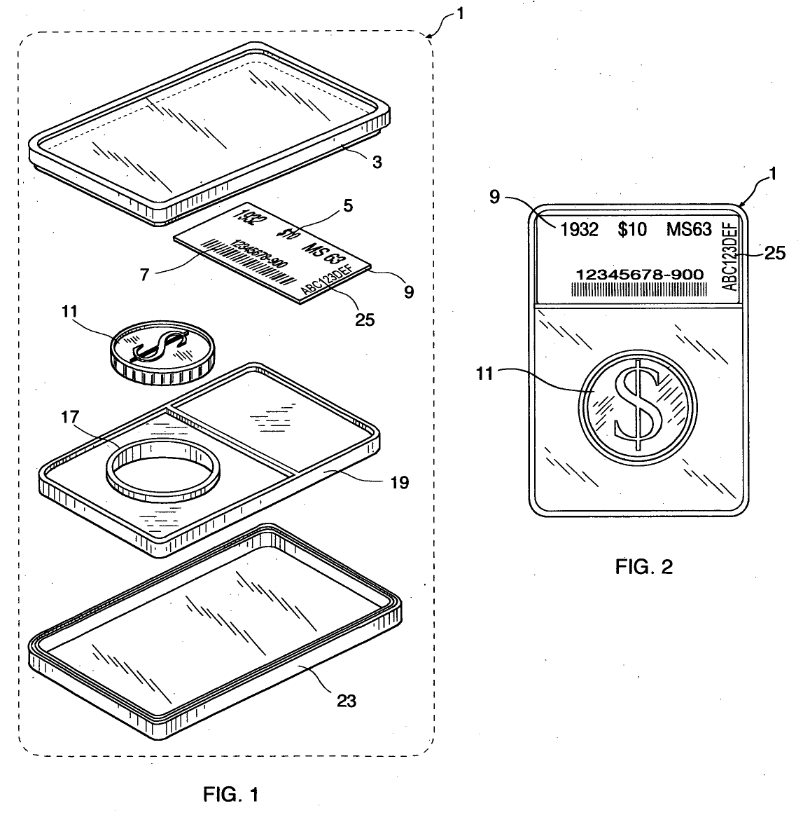

Referring now to the drawings, which are for the purpose of illustrating preferred embodiments of the present invention and are not for the purpose of limiting same, FIG. 1 shows a right front perspective, exploded view of a present invention device shown disassembled. A protection and identification device for a collectable object 1, is shown comprising a collectible holder having an upper housing 3 and a lower housing 23 that are formed for assembly with a collectable object, such as coin 11. Other collectable objects such as stamps, currency, gemstones, baseball cards, etc., are additional examples of collectable objects that would be applicable to the present invention. The holder housings 3 and 23 may be made of a clear plastic, such as acrylic, to provide protection and viewing for a collectable object, such as coin 11. A core component 19 is a method of securing collectable coin 11, to a preformed cavity 17 that is cut through core component 19 for viewing coin 11 on both sides, the obverse side (front) and reverse side (rear) of the coin. A certification service's certification authentication label, in the form of barcode label 9, is nondetachably secured within upper housing 3 and lower housing 23 by a method that resists disassembly, such as ultrasonic welding of the upper and lower housings 3 and 23 during an assembly process. “Nondetachable” shall mean resists detachment. Barcode label 9 would typically display basic certified information 5 of coin 11 such as the date, denomination and grade and may comprise a corresponding barcode/serial number 7 correlating to the certification data of coin 11. Additional information may also be displayed depending on the surface area of barcode label 9. A covert identification marking 25 is printed or adhered to barcode label 9. Within the scope of the present invention and apparent to those skilled in the art, the covert identification marking 25 may be printed or secured in variable locations within or affixed to the authentication and identification device 1, in a method that promotes non-detachment. A “covert identification marking” shall mean an identification marking, such as an alphanumeric marking, that promotes visual concealment and inhibits reproduction by traditional scanning devices and photocopy devices. A scanner is a device that optically scans images, printed text, handwriting, or an object, and converts it to a digital image. A photocopier effectively consists of an integrated scanner and laser printer. There are various known methods that would promote concealment of covert identification marking 25 and provide a method that inhibits reproduction by traditional scanners and photocopy devices. One method, for example, would be to print covert identification marking in a visible color that has minimal hue and tonal contrast with the background surface, thus inhibiting detection by a user and reproduction by scanning and photocopy devices. Another method, for example, would be to print covert identification marking 25 with opaque/transparent ink that is visible to a user only when viewed at an angle. Transparent ink (sometimes also referred to as Pearl Luster or Pearl Essence) is predominantly undetectable by scanners or photocopiers. Optically variable inks are similar to opaque/transparent inks, and change color depending on the angle at which they are viewed. Viewed perpendicularly, optically variable ink may be imperceptible to a user, or scanning and photocopy devices, but when viewed at an angle the ink reveals a color that is visibly discernable. Yet another method, for example, would employ the printing of covert identification marking 25 with Ultraviolet (UV) invisible florescent ink that is colorless or transparent until exposed to a UV light source. Information printed with invisible fluorescent inks that inhibit user detection, partially or entirely, and reproduction by scanning devices and photocopy devices. Furthermore, the acrylic surface of viewable holder, as shown in this embodiment as upper housing 3, may utilize a manufacturing treatment such as a treatment of the acrylic material that distorts perpendicular viewing, or a granular-frosted surface relative to the viewing proximity of covert identification marking 25, that inhibits reproduction by scanning devices and photocopy devices. Covert identification marking 25 would typically comprise an alphanumeric code that acts as a unique password to enable a user via a computerized device, to view at least one digital image of coin 11, to aid the user in the authentication of coin 11. The most common form of a computerized device is a traditional personal computer (PC) with Internet access capability. Other computerized devices may include, for example, laptops, Personal Digital Assistants (PDAs) and cellular phones. A user authentication protocol would typically employ a user to connect to a predetermined website URL (Uniform Resource Locator), such as the certification service's website that stores one or more digital images of coin 11 in a predetermined database. A user would then input covert identification marking 25 according to a Graphical User Interface (GUI). The website would then enable a user to view digital image/s of coin 11 and may include correlating authentication data to aid the user in the authentication of coin 11. Covert identification marking 25 may further provide a user access to additional information of coin 11, such as the valuation, survival populations, and interesting historical information related to coin 11. The image/s of coin 11 and/or related information may be stored at the certification service's database or a predetermined linked database. Typically, at least (2) digital images would be practical for authentication and identification purposes of a collectable coin, an image of the obverse (front) and an image of the reverse (rear) of coin 11. Magnified full images or specific partial images of coin 11 may also be viewable, to enhance the inspection and authentication of coin 11. The digital images of coin 11 may be utilized by a user for the visual authentication and identification of the unique characteristics of coin 11, such as the striking characteristics, luster quality, coloration, planchet quality, abrasions, striking quality, date, mintmark, and die-variations. Additional security protocols may also be employed by the certification service's website, such as a user login and password protocol. Covert Identification marking 25 may be utilized by itself as a means to enable a user to view digital image/s and certification data of coin 11, or may be utilized in conjunction with barcode serial number 7, a user login and password, or a combination of these to facilitate variable user protocols for authentication and user identification. For example, serial number of barcode 7, may provide a dependent authentication relationship with covert identification marking 25, and may require a user to input both in either order of input, or as a string of characters, to effectuate the viewing of digital images, authentication data, and/or related information of coin 11. Within the scope of the present invention, covert identification marking 25 may comprise many forms of an identification marking such as a random alphanumeric marking, a barcode serial number, a portion of a barcode serial number, a coded marking such as a barcode marking, or an alphanumeric marking related to a barcode marking.

FIG. 2 shows a top plan view of a present invention device shown in FIG. 1. An authentication and identification device 1 is shown assembled providing a predetermined orientation for viewing coin 11, certification barcode label 9, and covert identification marking 25.

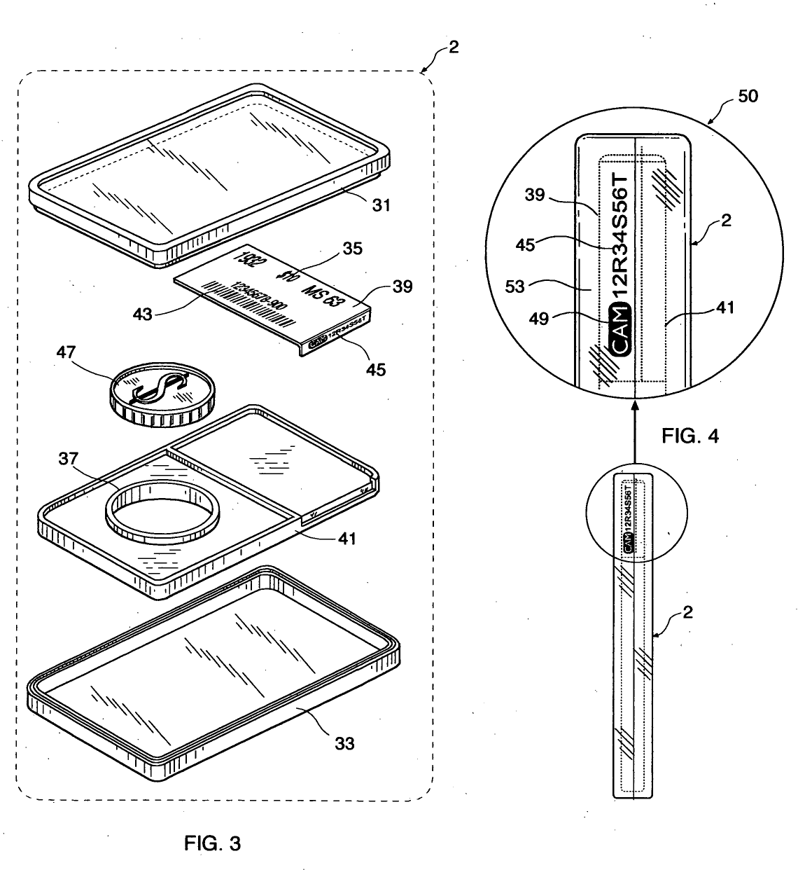

FIG. 3 shows a right front perspective, exploded view of another embodiment of the present invention device shown disassembled. A protection and identification device for a collectable object 2, is shown comprising a collectible holder having an upper housing 31 and a lower housing 33 that are formed for assembly with a collectable object, such as coin 47. The holder housings 31 and 33 may be made of a clear plastic, such as acrylic, to provide protection and viewing for a collectable object, such as coin 47. A core component 41 may secure the collectable coin 47, to preformed cavity 37 that is cut through core component 41 providing a predetermined viewing orientation for coin 47 on both sides, the obverse side (front) and reverse side (rear) of the coin. Coin 47 has been certified as authentic, and graded according to condition scale by a certification service. Certification authenticity, for example, may be depicted in the form of a certification service's label, such as barcode label 39, and is nondetachably secured within upper housing 31 and lower housing 33 by a method that resists disassembly. Such a method, for example may utilize ultrasonic welding of the upper and lower housings 31 and 33 during an assembly process. Barcode label 39 would typically display basic certified information 35, that is relevant to coin 47 such as the date, denomination, grade, of coin 47, and contain a corresponding barcode/serial number 43, that is related to certified information 35 of coin 47. A covert identification marking 45 is printed or adhered to barcode label 39. In this embodiment, for example, covert identification marking 45 is oriented for viewing on the narrow, planar viewing side surface of the authentication and identification device 2, to promote concealment and non-obvious visual detection by a user. Coin 47 has a predetermined orientation for viewing based on placement in core component 41. Covert identification marking 45 is non-viewable when coin 47 is viewed in the predetermined orientation for viewing the obverse and reverse surfaces of coin 47. Covert identification marking 45 inhibits reproduction by traditional scanners and photocopying devices, due to its small size and discreet viewable location on the narrow side of the authentication and identification device 2. Since the placement of covert identification marking 45 is non-viewable relative to the perpendicular viewing orientations of the obverse and reverse of coin 47, the viewing orientation of covert marking 45 would not typically be scanned for digital imaging. Additionally, the acrylic housing surface of the authentication and identification device 2 may have a thickness or manufacturing treatment, such as etching, that impedes focusing of covert identification marking 45 by scanning devices and photocopy devices, thus further inhibiting reproduction. Apparent to those skilled in the art, and within the scope of the present invention, additional security features may also be utilized in conjunction with covert identification marking 45, relative to the authentication and identification device 2, and may include for example, a watermark, a hologram, or a security thread embedded in a label. Covert identification marking 45 may also be an alphanumeric code comprising a minimal viewing size that further promotes concealment, and may require a user to utilize a simple tool, such as a magnifying glass to enhance readability. Coded identification marking 45 may also utilize a printing color hue or tonal value that provides minimal contrast with the color hue and tonal value of the background surface, shown in this figure as label 39, to further inhibit reproduction by scanning devices and photocopy devices. Yet another method, and within the scope of the present invention, acts to disguise covert identification marking 45 and thereby inhibits reproduction by scanning devices and photocopy devices. For example, scrambled indicia utilize methods and specific ink coloration that visually scrambles graphical information or code, and requires a decoding lens or similar tool to decipher specific information. Covert identification marking 45 may comprise many different forms of an identification marking, for example, covert identification marking may be a barcode serial number related to a separate barcode marking inherent to the authentication and identification device 2, such as a portion of a barcode serial number, the beginning or ending of a barcode serial number, or a separate alphanumeric marking that is unrelated to a barcode. Covert identification marking 45 would typically comprise a unique password composed of alphanumeric characters that enables a user via a computerized device with Internet access, to view and verify authentication data of coin 47. The authentication data would typically display basic certification data as determined by a certification service of coin 47, and related to barcode label 39, such as the date, denomination, grade, and serial number of coin 47. Covert identification marking 45 may also enable a user to view at least one digital image of coin 47 to aid the user in the authentication of coin 47, and further provide or link additional related information of coin 47, such as historical information related to coin 47 that is stored in the certification service's database or stored at another predetermined remote database.

FIG. 4 shows a right side assembled view of a present invention device shown in FIG. 3 with a magnified top portion of the present invention. An authentication and identification device for a collectable object 2 illustrates magnified portion 50 that illustrates an enlarged view of the right side of certification label 39 being retained to inner core 41 referenced in the exploded view of FIG. 3, and covert identification marking 45 that has been magnified to enhance readability. Covert identification marking 45 may also incorporate a graphical mark, such as a logo or trademark graphic as an additional security feature or marketing feature to promote the authentication capability to a user. For example, coded identification marking 45 may include a small graphic, such as graphic 49 with the letters “CAM,” which may be the certification services trademarked terminology or logo meaning “Certified Authentication Mark” (CAM). The certification service's (CAM) graphical marking 49 may be utilized by retailers, sellers, and auction agents as a trusted authentication symbol for collectable objects in the marketplace, and provide a buyer or seller greater confidence in authenticity.

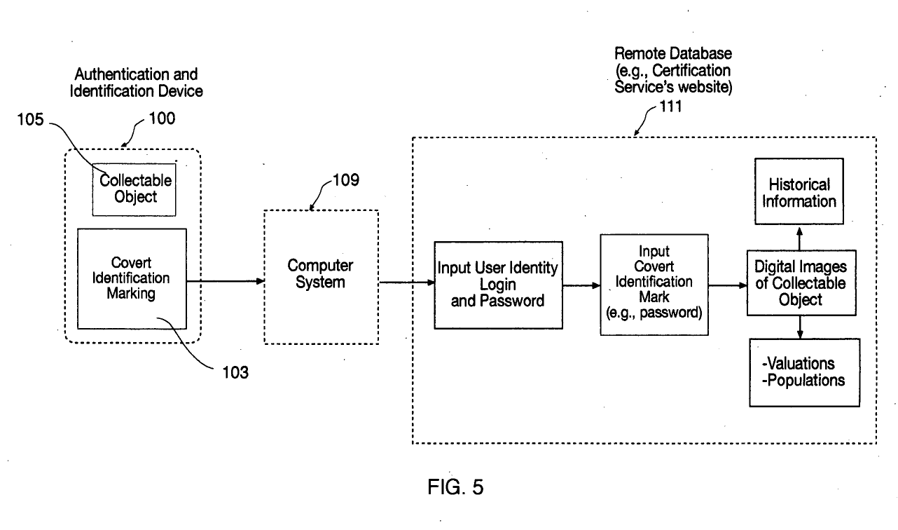

FIG. 5 shows a diagram of a present invention device that is similar to that shown in FIGS. 1 and 2 illustrating a typical corresponding interface with a standard computer system with Internet capability or equivalent system. An authentication and identification device for a collectable object 100, comprises a tamper resistant holder that houses collectable object 105 and covert identification marking 103 that is nondetachably secured to the authentication and identification device 100. Covert identification marking 103 is secured by means, for example, a label that is stored inside the holder device. Covert identification marking may be inherent to a certification services certification authentication label or may be separated from the certification authentication label, for example, comprising a separate label. The typical corresponding interface with a standard computer system is described. A user would link to a remote database by inputting a known URL, that may be identified on the authentication and identification device 100, such as a certification service's website 111. A user may be prompted to input a user login and password as a user identification protocol. A user would then input covert identification marking 103 to enable a user to view one or more digital images of collectable object 105, to aid the user in the authentication and identification of collectable object 105. Covert identification marking 103 may also enable the user to view information that is related to collectable object 105 and stored in database 111 or effectually linked to a predetermined remote database. Related information may include for instance, relevant historical information, current valuations, and survival populations of collectable object 105.

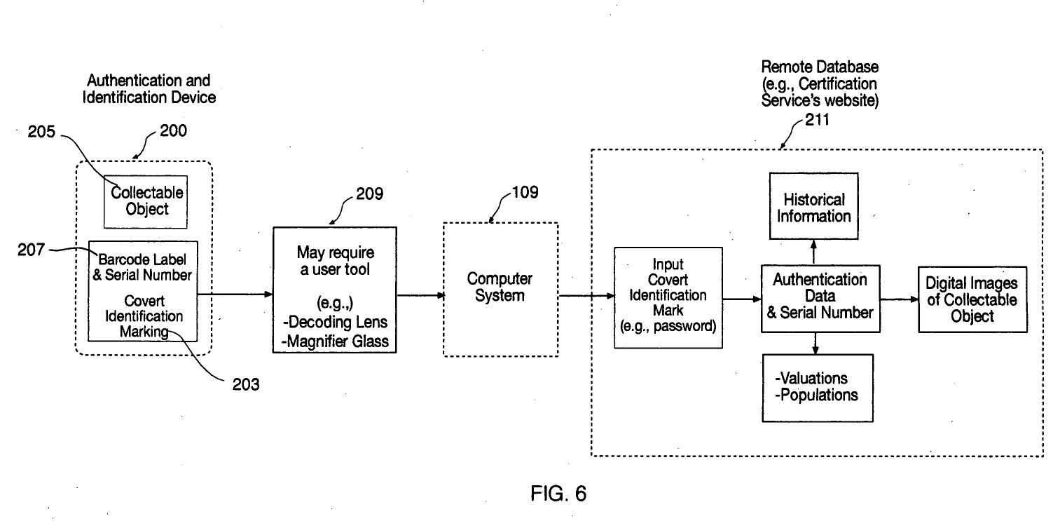

FIG. 6 shows a diagram of a present invention device that is similar to that shown in FIGS. 3 and 4 illustrating a typical corresponding interface with a standard computer system with Internet capability or equivalent system. Authentication and identification device 200, comprises a tamper resistant holder that houses collectable object 205 and covert identification marking 203 that are nondetachably secured to the authentication and identification device 200. Covert identification marking 203 is nondetachably secured by a means that promotes non-detachment of covert identification marking with the authentication and identification device 200, typically being stored within the holder or affixed to the holder by a nondetachable method. Such a label may be a certification services certification label 207 that comprises a barcode label. Covert identification marking 203 may require a user tool to aid in the readability of covert identification marking 203, such as a magnifying glass. The typical corresponding interface with a standard computer system is described. A user would link to a remote database by inputting a known URL, such as a certification service's website 211. A user would then input covert identification marking 203 according to a GUI, providing a user a means to view certification authenticity data relating to collectable object 205. Certification authenticity data may include, for example, the collectable object's grade, date, condition, and a correlating barcode serial number of collectable object 205. Covert identification marking 203 may also enable a user to view related information and digital images of collectable object 205 that are stored in database 211 or effectually linked with a predetermined remote database.

Upon reading and understanding the specification of the present invention described above, modifications and alterations will become apparent to those skilled in the art. It is intended that all such modifications and alterations be included insofar as they come within the scope of the patent as claimed or the equivalence thereof.

Having thus described the invention, the following is claimed:

1. An authentication and identification device for a collectable object, said device comprising:
a holder formed for assembly with at least one collectable object to provide protection and preservation of said collectable object, said holder further being formed so as to resist disassembly and separation with said collectable object; and,
a covert identification marking that provides a means for a user to view at least one digital image of said collectable object, said covert identification marking being nondetachably secured to said authentication and identification device, and said covert identification marking providing a means via a computerized device, for a user to view said digital image of said collectable object to aid said user in the authentication of said collectable object.

2. An authentication and identification device of claim 1 wherein, said covert identification marking provides a means for a user to view information relating to said collectable object.

3. An authentication and identification device of claim 1 wherein, said collectable object has a predetermined orientation for viewing, and, said covert identification marking is non-viewable when said collectable object is assembled with said holder and viewed in said predetermined orientation.

4. An authentication and identification device of claim 1 wherein, said covert identification marking inhibits reproduction by scanning devices and photocopy devices.

5. An authentication and identification device of claim 1 wherein, said covert identification marking inhibits visual detection by a user.

6. An authentication and identification device of claim 1 wherein, said covert identification marking requires a user tool to view said covert identification marking.

7. An authentication and identification device of claim 1 wherein, said covert identification marking is an alphanumeric marking.

8. An authentication and identification device of claim 4 wherein, said covert identification marking provides a means for a user to view information related to said collectable object.

9. An authentication and identification device of claim 4 wherein, said covert identification marking relates to a barcode marking that provides predetermined characteristics of said collectable object.

10. An authentication and identification device of claim 4 wherein, said collectable object is a coin.

11. An authentication and identification device for a collectable object, said device comprising:
a holder formed for assembly with at least one collectable object having certification authenticity, to provide protection and preservation of said collectable object, said holder further being formed so as to resist disassembly and separation with said collectable object; and,
a covert identification marking that provides a means for a user to view certification authenticity data relating to said collectable object, said covert identification marking being nondetachably secured to said authentication and identification device, and, said covert identification marking providing a means via a computerized device, for said user to view said certification authenticity data relating to said collectable object.

12. An authentication and identification device of claim 11 wherein, said covert identification marking provides a means for a user to view information related to said collectable object.

13. An authentication and identification device of claim 11 wherein, said collectable object has a predetermined orientation for viewing, and, said covert identification marking is non-viewable when said collectable object is assembled with said holder and viewed in said predetermined orientation.

14. An authentication and identification device of claim 11 wherein, said covert identification marking inhibits reproduction by scanning devices and photocopy devices.

15. An authentication and identification device of claim 11 wherein, said covert identification marking inhibits visual detection by a user.

16. An authentication and identification device of claim 11 wherein, said covert identification marking requires a user tool to view said covert identification marking.

17. An authentication and identification device of claim 11 wherein, said covert identification marking is an alphanumeric marking.

18. An authentication and identification device of claim 14 wherein, said covert identification marking provides a means for a user to view information related to said collectable object.

19. An authentication and identification device of claim 14 wherein, said covert identification marking relates to a barcode marking that provides predetermined characteristics of said collectable object.

20. An authentication and identification device of claim 14 wherein, said collectable object is a coin.
